(19) United States
(12) Patent Application Publication
(10) Pub. No.: US 2012/0080014 A1
(43) Pub. Date: Apr. 5, 2012

(54) CHARGE AIR COOLING DEVICE FOR A COMBUSTION ENGINE

(75) Inventors: Kai-Ove PIETSCH, Weiterstadt (DE); Lothar SEYBOLD, Nauheim (DE); Ioannis LAZARIDIS, Ruesselsheim (DE); Udo KNOBLOCH, Gau-Odernheim (DE)

(73) Assignee: GM GLOBAL TECHNOLOGY OPERATIONS LLC, Detroit, MI (US)

(21) Appl. No.: 13/249,357

(22) Filed: Sep. 30, 2011

(30) Foreign Application Priority Data
Oct. 1, 2010 (DE) 102010047092.9

(51) Int. Cl. F02M 31/20; B21D 53/02

(52) U.S. Cl. 123/542; 29/890.035

(57) ABSTRACT

A charge air cooling device is provided for a combustion engine with a first heat exchanger configured to transmit thermal energy of a charge airflow to a coolant and with a second heat exchanger by which thermal energy of the coolant can be discharged into the surroundings. The first heat exchanger is designed as coaxial tube heat exchanger, which directly connects a compressor provided for the combustion air to the engine.

### CROSS-REFERENCE TO RELATED APPLICATION

This application claims priority to German Patent Application No. 102010047092.9, filed Oct. 1, 2010, which is incorporated herein by reference in its entirety.

### TECHNICAL FIELD

The technical field relates to a charge air cooling device for a combustion engine in order to cool down the combustion air compressed by a compressor or charger prior to being fed into the combustion chamber of the engine.

### BACKGROUND

In charged combustion engines, the combustion air fed to the engine can be cooled down by means of a charge air cooler. By cooling the combustion air, its density can be increased and thus an increased amount of gas fed to the engine with the pressure remaining the same. In this manner, combustion processes, but particularly the power of the engine can be optimized or increased.

Popular charge air coolers are mostly designed as air-air heat exchangers. Since, in addition the cooled-down combustion air exiting the charge air cooler should have a temperature level below the temperature of the cooling water level of the combustion engine, known air-air charge air heat exchangers are to be typically arranged upstream of the radiator in the engine compartment of the motor vehicle. Furthermore, for example in DE 10 2009 028 487 A1 a cooler for cooling a gas flow of a combustion engine by means of a cooling medium is described, which comprises a first channel for conducting a gas flow and a second channel for conducting the cooling medium. First and second channel in this case are in thermal contact with each other, while a housing is designed as extruded part. On both the ends alongside the housing end caps are arranged, in which inlets to the first or the second channel located in the housing are formed.

The geometrical configurations of known charge air coolers restrict the flexibility of a charge air routing between compressor or charger and engine-end air supply sometimes substantially so. If for example instead of an air-air heat exchanger a fluid-cooled heat exchanger is provided as charge air cooler, this is accompanied by a substantial integrative effort. Thus, the entire engine package and the engine installation space distribution have to be adapted to the given shape of the heat exchanger. It is additionally desirable to continually improve the cooling output of a charge air cooler with the least possible installation space requirement.

### SUMMARY

The charge air cooling device is designed for a combustion engine of a motor vehicle. It comprises a first heat exchanger for transmitting thermal energy of a charge air flow to a coolant and a second heat exchanger, by means of which thermal energy of the coolant can be discharged to the surroundings. The first heat exchanger in this case serves for the cooling of the combustion air to be fed to the engine and compressed. The first heat exchanger bringing about a heat exchange between coolant and compressed combustion air in this case is designed as coaxial tube heat exchanger, which directly connects a compressor or charger provided for the combustion air to the combustion engine.

Here, it is more preferably provided that a gas-conducting tube of the coaxial tube heat exchanger comprises the entire gas-conducting section downstream of the compressor as far as to the intake manifold of the engine. This means, the entire intake tract of the combustion engine is designed as cooling section of a coaxial tube heat exchanger downstream of the compressor or charger as far as to the inlet in the engine. To that extent it is more preferably provided to adapt the coaxial tube heat exchanger to a predefined geometrical shape of the air supply and in the process optimize the effective length of the coaxial tube heat exchanger to improve its cooling output. Thus, in an advantageous further development the coaxial tube heat exchanger at one end is connected to an intake manifold of the engine and at the other end to the compressor or charger, which compresses the combustion air supplied from the outside to a predefined dimension.

According to a further embodiment it is furthermore provided that a cooling section of the coaxial tube heat exchanger comprises the entire or substantially the entire combustion air supply section located between the compressor and the combustion engine. Advantageously, the coaxial tube heat exchanger comprises an inner tube conducting the charge air and an outer tube radially enclosing the inner tube. The intermediate space formed by inner and outer tube roughly ring-shaped in cross section can be subjected to the admission of a coolant. The coolant is preferably present in liquid form or as a fluid, for example as a cooling water mixed with antifreeze agent.

By means of such a coaxial tube heat exchanger through which a cooling liquid flows the discharge of thermal energy from the first heat exchanger to a cooling circuit as against an air-air heat exchanger can be improved. In addition, the configuration of a heat exchanger that can be subjected to the admission of a cooling fluid makes possible almost any arrangement within the engine compartment. Thus, the heat exchanger—in contrast with an air-air heat exchanger—need not of necessity be arranged in an airflow.

According to a further embodiment a coolant inlet is provided on an engine end and a coolant outlet on a compressor end of the coaxial tube heat exchanger. To that extent, the coaxial tube heat exchanger is operated in the counter flow mode. While the combustion air to be cooled flows from the compressor to the engine, the coolant fed in via the inlet flows in the opposite direction to the coolant outlet in the ring-shaped intermediate space formed by inner tube and outer tube. This configuration of opposing liquid and gas flows in the inner and outer tube of the coaxial tube heat exchanger is provided to increase the overall cooling output of the first heat exchanger.

Advantageously, the charge air cooling device comprises a cooling circuit which in terms of flow interconnects the first and the second heat exchanger as well as a coolant pump. This cooling circuit preferably of a closed design is specifically and exclusively provided for cooling the coolant circulating in the circuit by means of the coolant pump. The second heat exchanger in this case is preferably designed as a liquid-air heat exchanger in order to be able to discharge thermal energy from the coolant to the surrounding air.

According to a further embodiment the coaxial tube heat exchanger comprises substantially straight line sections and/or sections following a curved course. The sections following a curved course in this case can be designed in all three space directions in order to be able to adapt the coaxial tube heat exchanger to a given geometry of the charge air routing. In particular, through the course of the coaxial tube heat exchanger curved at least in sections it can be variably and universally adapted to given installation dimensions of the charge air routing.

Here it is more preferably provided that the inner tube and/or that the outer tube in the region of curved sections and in the region of straight-line sections have a substantially identical or constant tube diameter. This serves to achieve that the coaxial tube heat exchanger also makes possible a heat exchange in sections following a curved course between the charge air flowing in the inner tube and the coolant flowing in the ring-shaped intermediate space between inner tube and outer tube.

In terms of manufacturing, such a coaxial tube heat exchanger designed curved in sections can be formed by assembling several inner tube and/or outer tube pieces. Thus, the inner tube and/or the outer tube can each be successively assembled of substantially straight tube pieces and curved tube pieces. Tube diameter and curvature radius in this case however have to be selected in such a manner that curved inner tube pieces and correspondingly curved outer tube pieces can be employed.

In another embodiment it is provided by contrast to form the inner tube and/or the outer tube as a continuous tube bent in sections. To this extent, inner and outer tubes which unitarily extend from the compressor as far as to the intake manifold of the combustion engine can be used for the coaxial tube heat exchanger. In terms of manufacturing, it is more preferably provided here to manufacture the coaxial tube heat exchanger of inner and outer tube cuts formed substantially straight and arranged nested within each other even before a forming process. The tubes arranged nested within each other in this case have to be brought into a shape that is predefined and curved at least in sections by means of a joint forming process, preferentially by means of a bending process. Here, almost any curvatures, even in different directions, can be realized in order to be able to adapt the coaxial tube heat exchanger as universally as possible to a predefined course of a charge air routing.

According to a further embodiment the inner tube on its inner wall comprises at least one air swirling element radially protruding to the inside, which for example is designed as swirling rib and/or as air swirling web, if applicable as turbulator. By means of at least one such air swirling element, preferably with several air swirling elements provided spaced in axial direction in the inner tube a specific swirling of the charged air flowing through the inner tube can be created, more preferably in order to intensify a heat exchange with the coolant flowing between inner tube and outer tube. Furthermore, it can be additionally provided to provide at least one end section of the coaxial tube heat exchanger with a length compensating element in order to be able to compensate for thermally induced length changes of the charge air cooling device, particularly of its coaxial tube heat exchanger.

In another embodiment a method for producing a coaxial tube heat exchanger is additionally provided, wherein for forming a heat exchanger section of curved design having an inner tube and an outer tube, an inner tube cut substantially of straight design is pushed in an outer tube cut of corresponding design and radially fixed in the latter. Following this it is provided to jointly bend the tubes pushed inside each other by means of one or by means of several tools into a predefined shape.

In order to avoid that the ring-shaped fluid-conducting intermediate space between inner and outer tube is changed through a bending operation, particularly made smaller, individual spaces, for example holding or fixing webs can be provided in the inner and outer tube sections according to a further development. The fixing webs in this case are to be preferably provided either on the outside of the inner tube or on the inside of the outer tube prior to a pushing into each other of inner and outer tube. If applicable, the individual tube cuts can already be provided in advance at least in sections with suitable spacer or holding webs.

In a further embodiment a combustion engine arrangement of a motor vehicle is additionally provided, which comprises a combustion engine, a charger or a compressor and a charge air cooling device described before, whose coaxial tube heat exchanger bridges the entire air-conducting section between the charger and the combustion engine. Furthermore, a motor vehicle is provided, which comprises a charge air cooling device described before.

### BRIEF DESCRIPTION OF THE FIGURES

The present invention will hereinafter be described in conjunction with the following drawing figures, wherein like numerals denote like elements, and:

FIG. 1 is a schematic representation of a charge air cooling device;

FIG. 2 is a schematic cross-sectional representation through a coaxial tube heat exchanger; and

FIG. 3 is an isolated schematic representation of a coaxial tube heat exchanger designed bent in sections.

### DETAILED DESCRIPTION

The following detailed description is merely exemplary in nature and is not intended to limit application and uses. Furthermore, there is no intention to be bound by any theory presented in the preceding background or summary or the following detailed description.

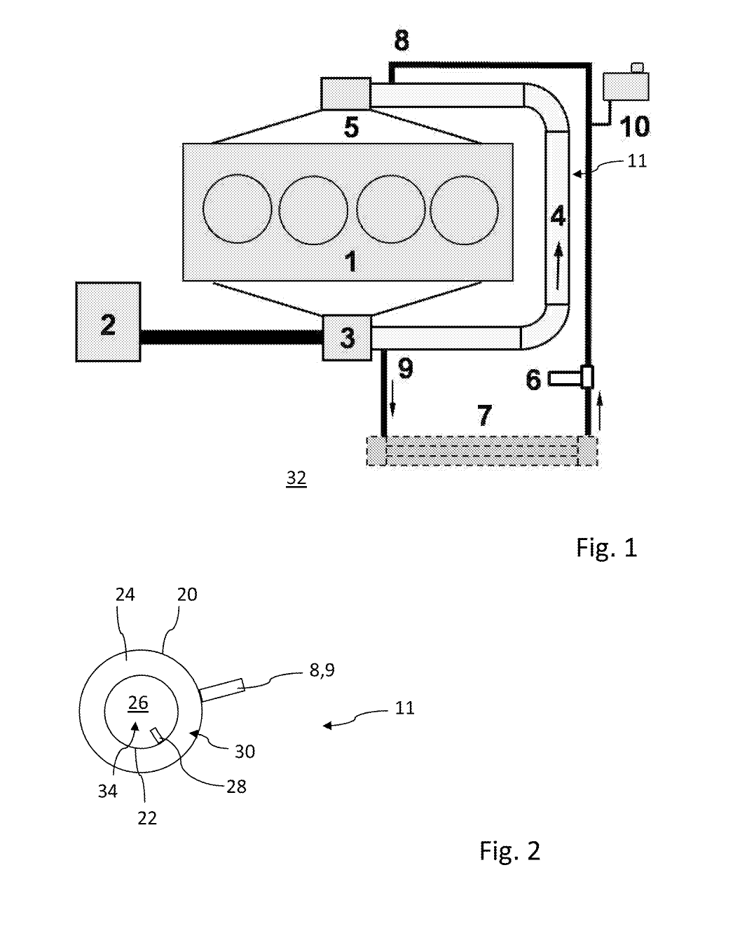

The charge air cooling device shown in FIG. 1 comprises a cooling circuit specifically provided for cooling the charge air, which in the present example is formed by a coaxial tube heat exchanger 11, a coolant outlet 9, a charge air cooler 7, a coolant pump 6, a coolant expansion tank 10 and a coolant inlet 8 terminating in the coaxial tube heat exchanger. The coaxial tube heat exchanger 11 extends between a compressor or charger 3 and an intake manifold 5 of the combustion engine 1. The entire section conducting combustion air located between the charger 3 and the intake manifold in this case is designed as cooling section 4 of the coaxial tube heat exchanger 11.

To that extent it is provided to form a predefined charge air routing downstream of the charger 3 and upstream of the combustion engine 1 almost entirely as cooling section of a coaxial tube heat exchanger 11. Because of this, the cooling output of a charge air cooling device can be increased and also flexibly and universally adapted to predefined installation space requirements. The intake tract for the combustion engine 1 is additionally provided with an air filter 2 on the air inlet side.

Cooling of the charge or combustion air 34 fed in and compressed by the charger 3 is performed according to the counter flow principle. Thus, the coolant 30 cooled down by means of the charge air and low-temperature cooler specifically provided for this purpose is fed to the coaxial tube heat exchanger 11 by means of the cooling pump 6 via the coolant inlet 8 in the vicinity of the intake manifold 5. The coolant 30 then preferably flows in a fluid-conducting channel against the flow direction of the charge air 34. The coolant 30 heated by the counter-flowing charge air 34 again flows out of the coaxial tube heat exchanger 11 at the coolant outlet 9 in the vicinity of the charger 3 and via the charge air cooler 7 substantially discharges the thermal energy absorbed by the charge air 34 to the surroundings 32.

The coaxial tube heat exchanger 11 is shown in FIG. 2 in a schematic cross-sectional representation. It comprises tubes arranged concentrically or coaxially to each other, namely an inner tube 22 and an outer tube 20 radially enclosing the inner tube 22. The inner tube 22 in this case acts as flow channel 26 for the charge air 34, while in an intermediate space 24 formed ring-like in cross section between inner tube 22 and outer tube 20 the preferably liquid coolant 30 flows in opposite direction.

Particularly the inner tube is designed for the thermal coupling of its inner space 26 to the ring-shaped intermediate space 24. Although the tubes 20, 22 merely indicated schematically in FIG. 2 are shown comparatively thin-walled, the wall thicknesses of the tubes 20, 22 can deviate from this almost randomly. It can also be provided for example that in particular the outer tube 20 has a wall thickness such that in the outer tube wall individual fluid-conducting channels can be provided in such a manner that the formation of an intermediate space 24 between inner tube 22 and outer tube 20 under certain conditions can also be omitted. The channels provided in the outer tube wall could to that extent also provide an exclusive fluid routing for the coolant 30.

Furthermore, a swirling element 28 radially protruding to the inside is indicated in FIG. 2, which for example can be designed as swirling rib or web, if applicable also as turbulator. By means of the swirling element 28 the compressed combustion air flowing in the inner space 26 of the inner tube 22 can be subjected to a specific swirling in order to improve the heat exchange between the coolant 30 and the compressed combustion air. The air swirling elements 28 in this case are arranged on the inner wall of the inner tube 22 in such a manner that a preferably optimized heat exchange with simultaneously low pressure loss or with low flow resistance in the interior tube 22 can be achieved.

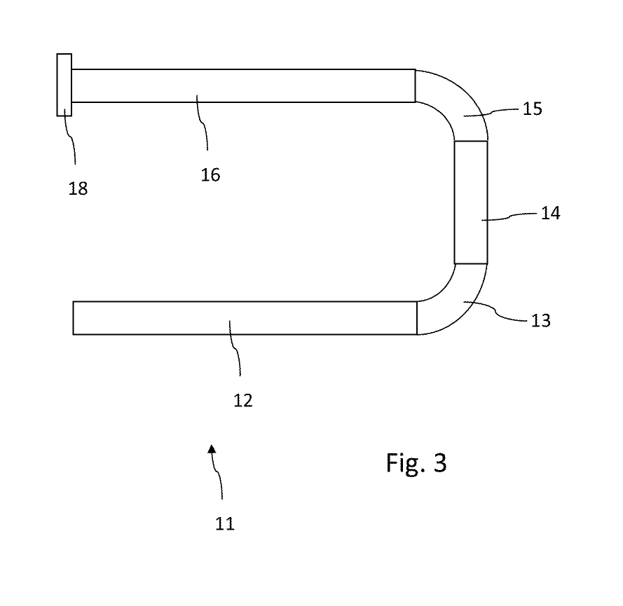

In the representation according to FIG. 3 the coaxial tube heat exchanger 11 is once more shown isolated. In the shown configuration it comprises tube sections 12, 14, 16 substantially designed straight, while the tube sections 12, 14 are connected to one another by means of a curved tube section 13 and the tube section 14, 16 via a further curved tube section 15. The individual tube sections 12, 13, 14, 15, 16 can be produced both for the inner tube 22 in each case of a tube piece, which are joined into a single inner or outer tube 22, 20 preferentially unchanged in cross section. However, as an alternative, it is also conceivable to achieve the tube arrangement shown in FIG. 3 by means of pushing into each other of two tube cuts initially designed substantially straight, which in a joint forming process are bent over in the region of the sections 13, 15 shown here by approximately 90°.

On the free end section of the coaxial tube section 16 a length compensating device 18 is additionally indicated, which is to compensate for possible thermally-induced length changes of the coaxial tube heat exchanger 11. The length compensating device can furthermore simplify the assembly process of the coaxial tube heat exchanger 11 and to that extent serves to facilitate assembly.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A charge air cooling device for a combustion engine:
a first coaxial tube heat exchanger configured to transmit thermal energy of a charge airflow to a coolant; and
a second heat exchanger configured to discharge the thermal energy of the coolant to a surrounding,
a compressor connected to the combustion engine with the first coaxial tube heat exchanger and configured to provide for a combustion air directly to the combustion engine.

2. The charge air cooling device according to claim 1, wherein the first coaxial tube heat exchanger comprises a first end connected to an intake manifold of the combustion engine and a second end connected to the compressor.

3. The charge air cooling device according to claim 1, further comprising an air supply connecting the compressor and the combustion engine and configure as a cooling section of the first coaxial tube heat exchanger.

4. The charge air cooling device according to claim 1,
wherein the first coaxial tube heat exchanger comprises an inner tube configured to conduct charge air and an outer tube radially enclosing the inner tube, and
wherein an intermediate space ring-shaped in cross section formed by the inner tube and the outer tube is configured to receive an admission of coolant.

5. The charge air cooling device according to claim 4, further comprising a coolant inlet on a first end of the combustion engine and a coolant outlet on a second end of the compressor of the first coaxial tube heat exchanger.

6. The charge air cooling device according to claim 1, further comprising a cooling circuit connecting a flow of the first coaxial tube heat exchanger, the second heat exchanger and a coolant pump.

7. The charge air cooling device according to claim 1, wherein the first coaxial tube heat exchanger comprises substantially straight sections following a curved course.

8. The charge air cooling device according to claim 1, wherein the first coaxial tube heat exchanger comprises sections following a curved course.

9. The charge air cooling device according to claim 4, wherein the inner tube in a region of the sections and in the substantially straight sections have a substantially identical tube diameter.

10. The charge air cooling device according to claim 4, wherein the outer tube in a region of the sections and in a second region of the straight sections have a substantially identical tube diameter.

11. The charge air cooling device according to claim 4, wherein the inner tube is assembled of a plurality of substantially straight tube pieces and curved tube pieces.

12. The charge air cooling device according to claim 4, wherein the outer tube is assembled of a plurality of substantially straight tube pieces and curved tube pieces.

13. The charge air cooling device according to claim 4, wherein the inner tube is a continuous tube bent in sections.

14. The charge air cooling device according to claim 4, wherein the outer tube is a continuous tube bent in sections.

15. The charge air cooling device according to claim 7, wherein the first coaxial tube heat exchanger is produced from inner tube cuts and outer tube cuts substantially formed straight and nested that are brought into a shape that is predefined and curved at least in sections with a common forming process.

16. The charge air cooling device according to claim 4, wherein the inner tube on an inner wall comprises an air swirling element radially protruding to an inside.

17. A method for producing a coaxial tube heat exchanger, comprising:
forming a section of curved design comprising an inner tube and an outer tube;
cutting the inner tube;
cutting the outer tube;
pushing the inner tube into the outer tube;
jointly bending the inner tube and the outer tube into a predefined shape with a forming tool.

18. A motor vehicle, comprising:
a combustion engine; and
a charge air cooling device, comprising:
a first coaxial tube heat exchanger configured to transmit thermal energy of a charge airflow to a coolant; and
a second heat exchanger configured to discharge the thermal energy of the coolant to a surrounding; and
a compressor connected to the combustion engine with the first coaxial tube heat exchanger and configured to provide for a combustion air directly to the combustion engine.
